(19) United States
(12) Patent Application Publication
(10) Pub. No.: US 2024/0169014 A1
(43) Pub. Date: May 23, 2024

(54) Apparatus and Method for Solving an N-Queen Problem

(71) Applicant: Korea University Research and Business Foundation, Seoul (KR)

(72) Inventors: Jun HEO, Seoul (KR); Jinyoung HA, Seoul (KR)

(73) Assignee: Korea University Research and Business Foundation, Seoul (KR)

(21) Appl. No.: 18/502,316

(22) Filed: Nov. 6, 2023

(30) Foreign Application Priority Data
Nov. 15, 2022 (KR) 10-2022-0152376
May 3, 2023 (KR) 10-2023-0057533

(51) Int. Cl. G06F 17/11

(52) U.S. Cl. CPC G06F 17/11

(57) ABSTRACT

The method for solving an N-queen problem includes: an initialization step of generating a quantum substitution matrix state which is a superposition of qubit states satisfying a row condition and a column condition of the N-queen problem; an Oracle step of performing an operation of inverting a phase of at least one entire correct answer state that satisfies a diagonal condition of the N-queen problem in the quantum substitution matrix state; an amplification step of amplifying an amplitude of at least one entire correct answer state of which the phase is inverted; amplifying the amplitude of at least one entire correct answer state to correspond to a predetermined value by performing the Oracle step and the amplification step repeatedly at a predetermined number of times; and acquiring one first correct answer state among at least one entire correct answer state based on observation of a qubit state.

### CROSS-REFERENCE TO RELATED APPLICATIONS

This application claims priority to and the benefit of Korean Patent Application No. 10-2022-0152376 filed in the Korean Intellectual Property Office on Nov. 15, 2022, and No. 10-2023-0057533 filed in the Korean Intellectual Property Office on May 3, 2023, the entire contents of which are incorporated herein by reference.

### TECHNICAL FIELD

The present disclosure relates to a method and an apparatus for solving an N-queen problem, and more particularly, to a method and an apparatus for generating a quantum substitution matrix state, and solving an N-queen problem by using the generated quantum substitution matrix state.

### BACKGROUND ART

A quantum computer may be a computer that processed data by using phenomena related to quantum mechanics such as quantum entanglement, quantum superposition, etc. The quantum entanglement may mean a state in which two or more states are connected to each other quantally, so that they cannot be handled separately in each state. The quantum superposition may mean that various result states by measurement are simultaneously present probabilistically before measuring the quantum state.

The quantum computer may solve an N-queen problem. The N-queen problem may be a problem in which N queens are arranged not to attack each other in a chess plate with N horizontal and vertical cells.

In 1996, Mr. Grover proposed a Grover algorithm, a search algorithm that can be used on the quantum computer, and the Grover algorithm uses the superposition phenomenon of the quantum mechanics to reduce the complexity of the search from existing O(N) to O(\sqrt{N}) when a size of a data space is N. In 2018, Jha developed an algorithm to distinguish a correct answer state and a non-correct answer state in the N-Queen problem using a quantum W state. However, the complexity of the N-Queen problem using the quantum computer in the related art is still high, so a lot of resources are required, so a method for lowering the complexity may be needed.

### SUMMARY OF THE INVENTION

The present disclosure has been made in an effort to provide a method and an apparatus for solving an N-queen problem.

Technical objects of the present disclosure are not restricted to the technical object mentioned as above. Other unmentioned technical objects will be apparently appreciated by those skilled in the art by referencing to the following description.

An exemplary embodiment of the present disclosure provides a method for solving an N-queen problem performed by a computing apparatus, which may include: an initialization step of generating a quantum substitution matrix state which is a superposition of qubit states satisfying a row condition and a column condition of the N-queen problem; an Oracle step of performing an operation of inverting a phase of at least one entire correct answer state that satisfies a diagonal condition of the N-queen problem in the quantum substitution matrix state; an amplification step of amplifying an amplitude of at least one entire correct answer state of which the phase is inverted; amplifying the amplitude of at least one entire correct answer state to correspond to a predetermined value by performing the Oracle step and the amplification step repeatedly at a predetermined number of times; and acquiring one first correct answer state among at least one entire correct answer state based on observation of a qubit state.

Alternatively, the N-queen problem may be a problem in which N queens are arranged not to attack each other in a chess plate with N horizontal and vertical cells. Here, the N may be a natural number.

Alternatively, the row condition may be a condition that satisfies xᵢ₁+xᵢ₂+ . . . +x_{iN}=1 which is a first equation for all i when respective cells (i,j) in a chess plate with N horizontal and vertical cells are xᵢⱼ, an empty cell is 0, and a cell with the queen is 1, wherein the N, the i, and the j are the natural number.

Alternatively, the column condition may be a condition that satisfies x₁ⱼ+x₂ⱼ+ . . . +x_{Nj}=1 which is a second equation for all j when respective cells (i,j) in the chess plate with N horizontal and vertical cells are xᵢⱼ, the empty cell is 0, and the cell with the queen is 1, wherein the N, the i, and the j are the natural number.

Alternatively, the diagonal condition may be a condition that satisfies a third equation when respective cells (i,j) in the chess plate with N horizontal and vertical cells are xᵢⱼ, the empty cell is 0, and the cell with the queen is 1, wherein the N, the i, and the j are the natural number, and the third equation may be

$$\begin{matrix}{\sum }_{i = 1}^{n - 1} {X}_{i , n - i} \leq 1 for all n ∈ \{ 3 , 4 , … , N + 1 \} \\ {\sum }_{i = 1}^{N} {X}_{i , N + n - i} \leq 1 for all n ∈ \{ 2 , 3 , … , N - 1 \} \\ {\sum }_{i = 1}^{N - n} {X}_{i , i + n} \leq 1 for all n ∈ \{ 0 , 1 , … , N - 2 \} \\ {\sum }_{i = 1}^{N - n} {X}_{+ ni , i} \leq 1 for all n ∈ \{ 1 , 2 , … , N - 2 \} .\end{matrix}$$

Alternatively, the quantum substitution matrix state may be

$$\frac{1}{\sqrt{N !}} \{ \vert \begin{matrix}1 & 0 & ⋯ & 0 \\ 0 & 1 & ⋯ & 0 \\ ⋮ & ⋮ & ⋱ & 0 \\ 0 & 0 & 0 & 1\end{matrix} 〉 + \vert \begin{matrix}0 & 1 & ⋯ & 0 \\ 1 & 0 & ⋯ & 0 \\ ⋮ & ⋮ & ⋱ & 0 \\ 0 & 0 & 0 & 1\end{matrix} 〉 + … + \vert \begin{matrix}0 & 0 & ⋯ & 1 \\ 0 & 0 & ⋯ & 0 \\ ⋮ & ⋮ & ⋱ & 0 \\ 1 & 0 & 0 & 0\end{matrix} 〉 \} .$$

Where the N may be the natural number.

Alternatively, the quantum substitution matrix state may be formed based on a quantum operation.

Alternatively, the quantum operation may include forming a state |W_{N} [symbol] by performing an operation W_{N} in qubits x₁₁, x₁₂, . . . , x_{1N}, performing an operation A_{N-1} in qubits xᵢⱼ (i, j=2, 3, . . . , N), and performing an operation C-SWAP (x₁ᵢ, xⱼ₁, xⱼᵢ) when respective cells (i,j) in the chess plate with N horizontal and vertical cells are xᵢⱼ, the empty cell is 0, the cell with the queen is 1, and the quantum operation is A_{N}.

Alternatively, the operation W_{N} may be an operation of converting a state |0 [symbol] of N-qubits to the state |W_{N} [symbol] .

Alternatively, the state |W_{N} [symbol] may be

$$\frac{1}{\sqrt{N}} ( \vert {N}_{1} 〉 + \vert {N}_{2} 〉 + … + \vert {N}_{N} 〉 ) .$$

Where the N may be the natural number.

Alternatively, the operation C-SWAP (x₁ᵢ, xⱼ₁, xⱼᵢ) may be an operation of exchanging two (xⱼ₁, xⱼᵢ) target qubits when a control qubit (x₁ᵢ) is 1 in three qubits.

Alternatively, another exemplary embodiment of the present disclosure provides a non-transitory computer readable medium storing a computer program, wherein the computer program comprises instructions for causing a processor of a computing apparatus for solving an N-queen problem to perform the following steps and the steps may include: an initialization step of generating a quantum substitution matrix state which is a superposition of qubit states satisfying a row condition and a column condition of the N-queen problem; an Oracle step of performing an operation of inverting a phase of at least one entire correct answer state that satisfies a diagonal condition of the N-queen problem in the quantum substitution matrix state; an amplification step of amplifying an amplitude of at least one entire correct answer state of which the phase is inverted; amplifying the amplitude of at least one entire correct answer state to correspond to a predetermined value by performing the Oracle step and the amplification step repeatedly at a predetermined number of times; and acquiring one first correct answer state among at least one entire correct answer state based on observation of a qubit state.

Alternatively, yet another exemplary embodiment of the present disclosure provides a computing apparatus for solving an n-queen problem, which may include: a processor including at least one core; and a memory for storing computer programs executable by the processor, in which the processor may be configured to perform initialization of generating a quantum substitution matrix state which is a superposition of qubit states satisfying a row condition and a column condition of the N-queen problem, perform an Oracle of performing an operation of inverting a phase of at least one entire correct answer state that satisfies a diagonal condition of the N-queen problem in the quantum substitution matrix state, perform an amplification of amplifying an amplitude of at least one entire correct answer state of which the phase is inverted, amplify the amplitude of at least one entire correct answer state to correspond to a predetermined value by performing the Oracle and the amplification repeatedly at a predetermined number of times, and acquire one first correct answer state among at least one entire correct answer state based on observation of a qubit state.

According to an exemplary embodiment of the present disclosure, an N-queen problem can be efficiently solved by using a quantum substitution matrix state which is a superposition of qubits that satisfy a row condition and a column condition of the N-queen problem.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a diagram illustrating a computing apparatus for solving the N-queen problem according to some exemplary embodiments of the present disclosure.

FIG. 2 is a flowchart illustrating a method for solving the N-queen problem performed by a computing apparatus according to some exemplary embodiments of the present disclosure.

FIG. 3 is a diagram for describing an equation conversion for solving the N-queen problem according to some exemplary embodiments of the present disclosure.

FIG. 4 is a diagram for describing a quantum operation forming an N² qubit quantum substitution matrix state according to some exemplary embodiments of the present disclosure.

FIG. 5 is a diagram related to a quantum circuit representing a diagonal condition of the N-queen problem according to some exemplary embodiments of the present disclosure.

FIG. 6 is a diagram related to a quantum circuit representing a diagonal condition of the N-queen problem according to some other exemplary embodiments of the present disclosure.

FIG. 7 is a diagram related to a quantum circuit that inverts a phase according to some exemplary embodiments of the present disclosure.

FIG. 8 is a diagram related to a quantum circuit that inverts a phase of at least one entire correct answer state satisfying the diagonal condition of the N-queen problem in a quantum substitution matrix state according to some exemplary embodiments of the present disclosure.

FIG. 9 is a diagram related to a quantum circuit for solving the N-queen problem performed by the computing apparatus according to some exemplary embodiments of the present disclosure.

FIG. 10 illustrates a simple and general schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

Further, it should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure terms represented by N-th such as first, second, or third are used for distinguishing at least one entity. For example, entities expressed as first and second may be the same as each other or different from each other.

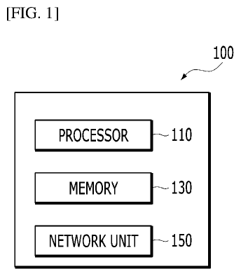

FIG. 1 is a diagram illustrating a computing apparatus for solving the N-queen problem according to some exemplary embodiments of the present disclosure.

In the present disclosure, the computing apparatus 100 may mean an arbitrary type of server or user terminal constituting a system for implementing exemplary embodiments of the present disclosure. The computing apparatus 100 may mean a quantum computing apparatus that performs a calculation by using quantum mechanical physical phenomena such as indexing information expression of quantum superposition and a parallel operation using quantum entanglement.

The computing apparatus 100 may include a processor 110, a memory 130, and a network unit 150. The processor 110 may be constituted by one or more cores and may include processors for data analysis and quantum processing, which include a central processing unit (CPU), a general purpose graphics processing unit (GPGPU), a tensor processing unit (TPU), and the like of the computing apparatus. The processor 110 may generally control an overall operation of the quantum computing apparatus 100. For example, the processor 110 may process signals, data information, etc., input or output through components included in the quantum computing apparatus 100. As another example, the processor 110 may read a computer program stored in the memory 130 to perform the quantum processing according to an exemplary embodiment of the present disclosure.

According to some exemplary embodiments of the present disclosure, the memory 130 may store any type of information generated or determined by the processor 110 or any type of information received by the network unit 150.

According to some exemplary embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing apparatus 100 may operate in connection with a web storage performing a storing function of the memory 130 on the Internet. The description of the memory is just an example and the present disclosure is not limited thereto. The network unit 150 according to some exemplary embodiments of the present disclosure may include an arbitrary wired/wireless communication network that may transmit/receive arbitrary type data and signals. The techniques described in this specification may also be used in other networks in addition to the aforementioned networks.

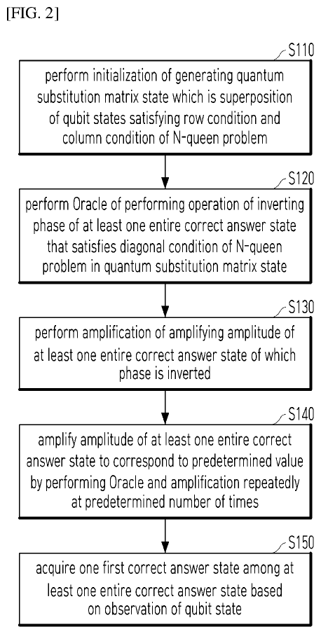

FIG. 2 is a flowchart illustrating a method for solving the N-queen problem performed by the computing apparatus according to some exemplary embodiments of the present disclosure.

Steps illustrated in FIG. 2 are exemplary steps. Therefore, it will also be apparent to those skilled in the art that some of the steps of FIG. 2 may be omitted or there may be additional steps within a range without departing from a spirit scope of the present disclosure. Further, specific contents regarding the components (e.g., the computing apparatus 100, etc.) disclosed in FIG. 2 may be replaced with the contents described through FIG. 1 above. The steps illustrated in FIG. 2 may be performed, for example, by the computing apparatus 100.

Referring to FIG. 2, the processor 110 of the computing apparatus 100 may perform initialization of generating a quantum substitution matrix state which is a superposition of a qubit state that satisfies the row condition and the column condition of the N-queen problem (S110).

The qubit may be a basic unit of information for processing data by using a phenomenon related to the quantum mechanics. The qubit may simultaneously express values corresponding to various bits by using the quantum superposition state. For example, the qubit may express respective values as probabilities such as ‘0 with a probability of 20% and 1 with a probability of 80%’. The qubit may be determined as one state while the quantum superposition state is released when being observed.

The N-queen problem may be a problem in which N queens are arranged not to attack each other in a chess plate with N horizontal and vertical cells. Here, N may be a natural number.

The processor 110 may express respective cells with a literal in the chess plate with N horizontal and vertical cells. For example, the processor 110 may determine respective cells (i,j) in the chess plate with N horizontal and vertical cells as xᵢⱼ. The processor 110 may determine an empty cell without the queen as 0 and a cell with the queen as 1. Here, N, i, and j may be the natural number.

The literal may be that a character string itself may represent a value in a program language. For example, a character string 90 may be a literal representing a value of 90 in x=“90”.

The row condition of the N-queen problem may be a condition that satisfies a first equation for all i when the respective cells (i,j) in the chess plate with N horizontal and vertical cells are xᵢⱼ, the empty cell is 0, and the cell with the queen is 1. The first equation may correspond to the following equation.

xᵢ₁+xᵢ₂+ . . . +x_{iN}=1 [Equation 1]

Here, N, i, and j may be the natural number.

The column condition of the N-queen problem may be a condition that satisfies a second equation for all j when the respective cells (i,j) in the chess plate with N horizontal and vertical cells are xᵢⱼ, the empty cell is 0, and the cell with the queen is 1. The second equation may correspond to the following equation.

x₁ⱼ+x₂ⱼ+ . . . +x_{Nj}=1 [Equation 2]

Here, N, i, and j may be the natural number.

The processor 110 may perform an Oracle that performs an operation of inverting the phase of at least one entire correct answer state that satisfies the diagonal condition of the N-queen problem in the quantum substitution matrix state (S120).

The diagonal condition of the N-queen problem may be a condition that satisfies a third equation when the respective cells (i,j) in the chess plate with N horizontal and vertical cells are xᵢⱼ, the empty cell is 0, and the cell with the queen is 1.

The third equation may correspond to the following equation.

$$\begin{matrix}{\sum }_{i = 1}^{n - 1} {x}_{i , n - i} \leq 1 for all n ∈ \{ 3 , 4 , … , N + 1 \} \\ {\sum }_{i = 1}^{n - 1} {x}_{i , N + n - i} \leq 1 for all n ∈ \{ 2 , 3 , … , N - 1 \} \\ {\sum }_{i = 1}^{n - 1} {x}_{i , i + n} \leq 1 for all n ∈ \{ 0 , 1 , … , N - 2 \} \\ {\sum }_{i = 1}^{n - 1} {x}_{+ ni , i} \leq 1 for all n ∈ \{ 1 , 2 , … , N - 2 \}\end{matrix} \qquad [ Equation 3 ]$$

Here, N, i, and j may be the natural number.

The quantum substitution matrix state may be a superposition of the qubit states that satisfy the row condition and the column condition of the N-queen problem.

The quantum substitution matrix state may be

$$\frac{1}{\sqrt{N !}} \{ \vert \begin{matrix}1 & 0 & ⋯ & 0 \\ 0 & 1 & ⋯ & 0 \\ ⋮ & ⋮ & ⋱ & 0 \\ 0 & 0 & 0 & 1\end{matrix} 〉 + \vert \begin{matrix}0 & 1 & ⋯ & 0 \\ 1 & 0 & ⋯ & 0 \\ ⋮ & ⋮ & ⋱ & 0 \\ 0 & 0 & 0 & 1\end{matrix} 〉 + … + \vert \begin{matrix}0 & 0 & ⋯ & 1 \\ 0 & 0 & ⋯ & 0 \\ ⋮ & ⋮ & ⋱ & 0 \\ 1 & 0 & 0 & 0\end{matrix} 〉 \} .$$

Here, N may be the natural number. The N may be the number of qubit states superposed, which satisfy the row condition and the column condition of the N-queen problem.

The number of combinations of literals which satisfy the row condition and the column condition of the N-queen problem may be N!. Therefore, the processor 110 may set the number of times of repeatedly performing an Oracle step S120 and an amplification step S130 to O(\sqrt{M/L}) when using the quantum substitution matrix state. In the conventional scheme, only a superposition that satisfies only the row condition is used. Therefore, in the conventional scheme, the number of times of repeatedly performing the steps as O(\sqrt{N^{N}/L}) and more repetitions are performed than the present disclosure. As a result, in the present disclosure, since the number of times of repeatedly performing is smaller than the conventional scheme, the N-queen problem may be solved more quickly. Here, N may be the natural number. The N may be the number of qubit states superposed, which satisfy the row condition and the column condition of the N-queen problem. Here, L may be the number of correct answers. For example, L may be the number of qubits which satisfy the row condition, the column condition, and the diagonal condition of the N-queen problem.

The quantum substitution matrix state may be formed based on the quantum operation. Therefore, the processor 110 may form the quantum substitution matrix state based on the quantum operation.

When the respective cells (i,j) in the chess plate with N horizontal and vertical cells are xᵢⱼ, the empty cell is 0, and the cell with the queen is 1, the quantum operation A_{N} may form a state |W_{N} [symbol] by performing an operation W_{N} in qubits x₁₁, x₁₂, . . . , x_{1N}. The quantum operation may perform an operation A_{N-1} in qubits xᵢⱼ (i, j=2, 3, . . . , N). The quantum operation may perform an operation C-SWAP (x₁ᵢ, xⱼ₁, xᵢⱼ). Therefore, the processor 110 may form the state |W_{N} [symbol] by performing the operation W_{N} in the qubits x₁₁, x₁₂, . . . , x_{1N}. The processor 110 may perform the operation A_{N-1} in qubits xᵢⱼ (i, j=2, 3, . . . , N). The processor 110 perform the operation C-SWAP (x₁ᵢ, xⱼ₁, xᵢⱼ).

The operation W_{N} may be an operation of converting a state |0 [symbol] of N-qubits to the state |W_{N} [symbol] . Here, the N may be the natural number.

The state |W_{N} [symbol] may be

$$\frac{1}{\sqrt{N}} ( \vert {N}_{1} 〉 + \vert {N}_{2} 〉 + … + \vert {N}_{N} 〉 ) .$$

Here, the N may be the natural number.

The operation C-SWAP (x₁ᵢ, xⱼ₁, xᵢⱼ) may be an operation of exchanging two (xⱼ₁, xᵢⱼ) target qubits when a control qubit (x₁ᵢ) is 1 in three qubits.

The processor 110 perform an amplification of amplifying an amplitude of at least one entire correct answer state of which phase is inverted (S130).

At least one entire correct answer state may be a qubit state which satisfies the row condition, the column condition, and the diagonal condition of the N-queen problem.

An operation B for the amplification may correspond to Equation 4 below.

B=A_{N} [symbol] P₀A_{N} [Equation 4]

Here, A_{N} [symbol] may be an inverse operation of A_{N} which is the operation that makes the quantum substitution matrix state. P₀ may be a diagonal matrix 2^{N}^{²}×2^{N}^{²} having a first row component of 1 and all other row components of −1. Since required resources of A_{N} are most among various elements, a time complexity of a quantum circuit performing the amplification may be O(N³).

The processor 110 performs the Oracle step S120 and the amplification step S130 repeatedly at a predetermined number of times to amplify the amplitude of at least one entire correct answer state to correspond to a predetermined value (S140).

The predetermined number of times may be O(\sqrt{N!/L}). The predetermined value may be 1. The N may be the number of qubit states superposed, which satisfy the row condition and the column condition of the N-queen problem. Here, L may be the number of correct answers. For example, L may be the number of qubits which satisfy the row condition, the column condition, and the diagonal condition of the N-queen problem. However, the predetermined number of times and/or the predetermined value are not limited thereto, and may be set different according to a situation or user's setting.

The processor 110 amplifies the amplitude of at least one entire correct answer state to correspond to the predetermined value to increase a deviation between at least one entire correct answer state and a non-correct answer state. When the deviation between at least one entire correct answer state and the non-correct answer state is increased, it may be easy to observe the correct answer state.

The processor 110 may acquire one first correct answer state among one or more entire correct answer states based on the observation of the qubit state (S150). The processor 110 observes the qubit state in the at least one amplified entire correct answer to acquire one first correct answer state among one or more entire correct answer states except for the non-correct answer state.

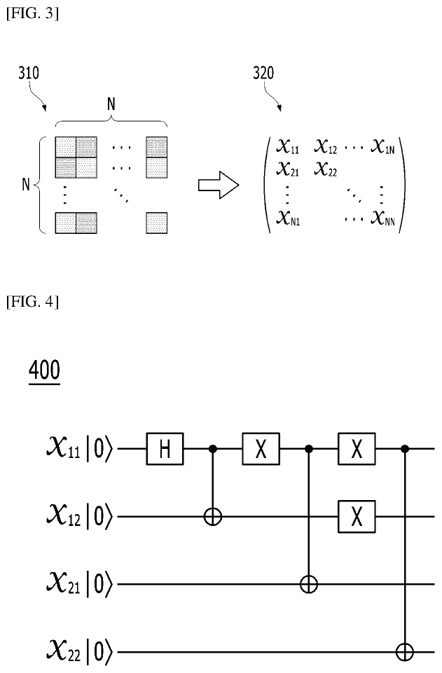

FIG. 3 is a diagram for describing an equation conversion for solving the N-queen problem according to some exemplary embodiments of the present disclosure. Referring to FIG. 3, the processor 110 may convert the N-Queen problem to a Boolean algebra equation. The Boolean algebra equation may be an algebra equation that handles a logical operation with respect to a value of 1 or 0. For example, the processor 110 may express respective cells with the literal in the chess plate 310 with N horizontal and vertical cells. The processor 110 may determine respective cells (i,j) in the chess plate with N horizontal and vertical cells as xᵢⱼ 320. For example, the processor 110 may determine a first cell which is an uppermost left cell as x₁₁ and a last cell which is a lowermost right cell as x_{NN}. The processor 110 may determine an empty cell without the queen as 0 and a cell with the queen as 1. Here, N, i, and j may be the natural number.

A method of defining the quantum operation forming the N² qubit quantum substitution matrix state as A_{N} and inductively configuring the quantum operation A_{N} will be described below.

FIG. 4 is a diagram for describing a quantum operation forming an N² qubit quantum substitution matrix state according to some exemplary embodiments of the present disclosure. Specifically, FIG. 4 may be a diagram illustrating an operation A₂ by a quantum circuit 400 according to some exemplary embodiments of the present disclosure. A process of the quantum circuit 400 may correspond to Equation 5 below.

$$\vert \begin{matrix}{x}_{11} & {x}_{12} \\ {x}_{21} & {x}_{22}\end{matrix} 〉 = \vert \begin{matrix}0 & 0 \\ 0 & 0\end{matrix} 〉 ↦ \frac{1}{\sqrt{2}} \{ \vert \begin{matrix}1 & 0 \\ 0 & 1\end{matrix} 〉 + \vert \begin{matrix}0 & 1 \\ 1 & 0\end{matrix} 〉 \} \qquad [ Equation 5 ]$$

In an exemplary embodiment of the present disclosure, the processor 110 may perform an operation A₃ as below.

The processor 110 may form a state |W₃ [symbol] by performing the operation W₃ in qubits x₁₁, x₁₂, x₁₃. The processor 110 may perform the operation A₂ in qubits xᵢⱼ (i, j=2, 3). The processor 110 may perform an operation C-SWAP (x₁ᵢ, xⱼ₁, xᵢⱼ)(i, j=2, 3). Here, the operation W₃ may be a quantum operation that makes a 3-qubit W state (the state |W₃ [symbol] ).

In an exemplary embodiment of the present disclosure, the processor 110 may perform an operation A₄ as below.

The processor 110 may form a state |W₄ [symbol] by performing the operation W₄ in qubits x₁₁, x₁₂, x₁₃, x₁₄. The processor 110 may perform the operation A₃ in qubits xᵢⱼ (i, j=2, 3, 4). The processor 110 may perform an operation C-SWAP (x₁ᵢ, xⱼ₁, xᵢⱼ)(i, j=2, 3, 4). Here, the operation W₄ may be a quantum operation that makes a 4-qubit W state (the state |W₄ [symbol] ).

Therefore, the processor 110 may perform a quantum operation (operation A_{N}) as below.

The processor 110 may form a state |W_{N} [symbol] by performing the operation W_{N} in qubits x₁₁, x₁₂, . . . , x_{1N}. The processor 110 may perform the operation A_{N-1} in qubits xᵢⱼ (i, j=2, 3, . . . , N). The processor 110 may perform an operation C-SWAP (x₁ᵢ, xⱼ₁, xᵢⱼ)(i, j=2, 3, . . . , N).

As described above, the quantum operation (operation A_{N}) may be configured by using the operation A_{N-1}, the operation W_{N}, and/or the operation C-SWAP.

In an exemplary embodiment of the present disclosure, when the number of gates required for an arbitrary operation X is N(X), N(W_{N}) may be 2N. N(A_{N}) may correspond to Equation 6 below.

$$N ( {A}_{N} ) = N ( {A}_{N - 1} ) + N ( {W}_{N} ) + {( N - 1 )}^{2} \to N ( {A}_{N} ) = N ( N + 1 ) + \frac{N ( N - 1 ) ( 2 N - 1 )}{6} + 4 \qquad [ Equation 6 ]$$

Therefore, it can be seen that the time complexity of the operation A_{N} among various elements may be effectively implemented as O(N³).

Meanwhile, in some exemplary embodiments of the present disclosure, the processor 110 may configure an Oracle operation in order to perform an Oracle that performs an operation of inverting the phase of at least one entire correct answer state that satisfies the diagonal condition of the N-queen problem in the quantum substitution matrix state. An Oracle operator may correspond to Equation 7 below.

$$\{ \begin{matrix}O \vert x 〉 = \vert x 〉 & if x \neq w \\ O \vert w 〉 = - \vert w 〉 & \end{matrix} \qquad [ Equation 7 ]$$

Here, |x [symbol] may be the non-correct answer state. |w [symbol] may be the correct answer state. Therefore, the processor 110 may perform an operation of inverting only a phase of an input (e.g., entire correct answer state) to be found among superposed inputs (e.g., the quantum substitution matrix state which is a superposition of qubit states that satisfy the row condition and the column condition) through an Oracle operator.

A state corresponding to the correct answer in the N-queen problem should satisfy the row condition, the column condition, and the diagonal condition. The processor 110 uses the quantum substitution matrix state in the initialization step S110 to already satisfy the row condition and the column condition. The processor 110 may implement the Oracle operation by performing an operation of inverting the phase of the state satisfying the diagonal condition. The diagonal condition of the N-queen problem may correspond to Equation 3 described above. A method for representing Equation 3 by the quantum circuit through an example when n=4 in an equation

$${\sum }_{i = 1}^{n - 1} {x}_{i , n - i} \leq 1$$

for all n∈{3, 4, . . . , N+1} of Equation 3 will be described below. When a case where n=3 in the equation

$${\sum }_{i = 1}^{n - 1} {x}_{i , n - i} \leq 1$$

for all n∈{3, 4, . . . , N+1} is reconfigured by using a NOT operation, an AND operation, and/or an XOR operation, the equation may correspond to Equation 8 below.

\overline{(x₂₁\hat{ }x₁₂)}=1 [Equation 8]

When a case where n=5 in the equation

$${\sum }_{i = 1}^{n - 1} {x}_{i , n - i} \leq 1$$

for all n∈{3, 4, . . . , N+1} is reconfigured by using the NOT operation, the AND operation, and/or the XOR operation, the equation may correspond to Equation 9 below.

(x₁₄\hat{ }x̅₂̅₃̅\hat{ }x̅₃̅₂̅\hat{ }x̅₄̅₁̅)⊕(x̅₁̅₄̅\hat{ }x₂₃\hat{ }x̅₃̅₂̅\hat{ }x̅₄̅₁̅)⊕(x̅₁̅₄̅\hat{ }x̅₂̅₃̅\hat{ }x₃₂\hat{ }x̅₄̅₁̅)⊕(x̅₁̅₄̅\hat{ }x̅₂̅₃̅\hat{ }x̅₃̅₂̅)=1 [Equation 9]

Here, the NOT operation, the AND operation, and the XOR operation which are logical operations may be represented as in Table 1 below in the quantum circuit.

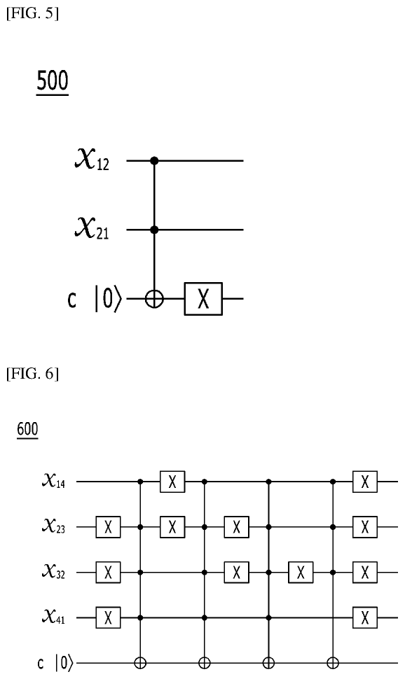

Therefore, the processor 110 may perform the logical operations by using an X gate Ā, a CNOT gate A⊕B, and a Toffoli gate A\hat{ }B which are quantum gates. Equation 8 may be represented by the quantum circuit as in FIG. 5. FIG. 5 is a diagram related to a quantum circuit representing a diagonal condition of the N-queen problem according to some exemplary embodiments of the present disclosure. Specifically, FIG. 5 may illustrate a quantum circuit configured when the number of added literals is 2 in Equation 3 according to some exemplary embodiments of the present disclosure.

Referring to FIG. 5, c may be a qubit storing a value of Equation 8 in a quantum circuit 500 for Equation 8.

Further, Equation 9 may be represented by the quantum circuit as in FIG. 6. FIG. 6 is a diagram related to a quantum circuit representing a diagonal condition of the N-queen problem according to some other exemplary embodiments of the present disclosure. Specifically, FIG. 6 may illustrate a quantum circuit configured when the number of added literals is not 2 in Equation 4 according to some exemplary embodiments of the present disclosure.

Referring to FIG. 6, c may be a qubit storing a value of Equation 9 in a quantum circuit 600 for Equation 9.

For each n of Equation 3, a new c qubit may be required. Therefore, when the diagonal condition is represented by the quantum circuit, 4N-6 c qubits may be required.

The processor 110 may invert the phase of the literal when values of all c qubits are 1 by using the Oracle operator. An equation for performing the phase inversion may correspond to Equation 10 below.

$$\frac{\vert 0 〉 - \vert 1 〉}{\sqrt{2}} {\to }^{X} \frac{\vert 1 〉 - \vert 0 〉}{\sqrt{2}} = - \frac{\vert 0 〉 - \vert 1 〉}{\sqrt{2}} \qquad [ Equation 10 ]$$

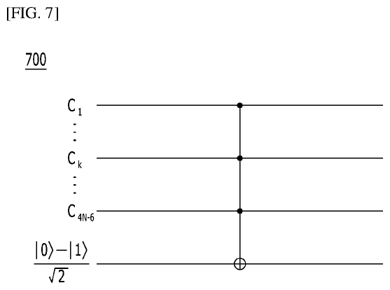

A quantum circuit that inverts the phase according to the c qubit value by using Equation 10 may correspond to a quantum circuit 700 of FIG. 7. FIG. 7 is a diagram related to a quantum circuit that inverts a phase according to some exemplary embodiments of the present disclosure.

Referring to FIG. 7, the number of qubits additionally required for configuring the circuit 700 for the phase inversion may be 1. Therefore, by adding one c qubit additionally required for configuring the circuit 700 for the phase inversion to 4N-6 c qubits required when the diagonal condition is represented by the quantum circuit, the number of qubits additionally required for configuring the quantum circuit of the Oracle operation may be 4N-5.

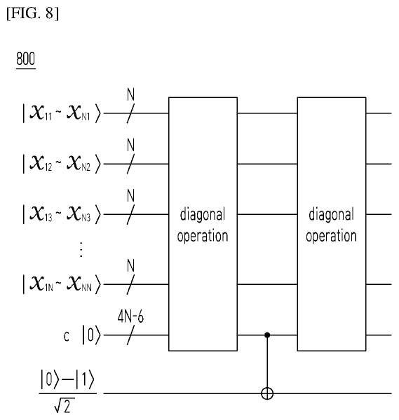

An entire circuit diagram of the Oracle operation may be illustrated in FIG. 8. FIG. 8 is a diagram related to a quantum circuit that inverts a phase of at least one entire correct answer state satisfying the diagonal condition of the N-queen problem in a quantum substitution matrix state according to some exemplary embodiments of the present disclosure.

Referring to FIG. 8, the processor 110 performs a diagonal operation once more for reuse of the c qubit after the phase inversion to return all c qubits to the state |0 [symbol] . In the diagonal operation, O(N) gates may be used for each n. Therefore, the time complexity of the circuit 800 of the Oracle operation may be O(N²). In addition, an operation B for the amplification may correspond to Equation 4 described above. Since required resources of A_{N} are most among various elements, a time complexity of a quantum circuit performing the amplification may be O(N³) described above.

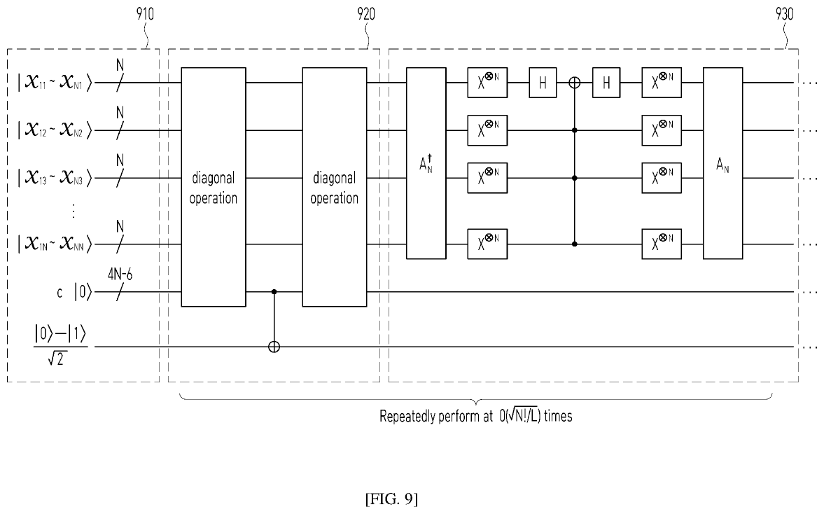

According to some exemplary embodiments of the present disclosure, an entire circuit diagram for solving the N-queen problem in the processor 110 may be illustrated in FIG. 9. FIG. 9 is a diagram related to a quantum circuit for solving the N-queen problem performed by the computing apparatus according to some exemplary embodiments of the present disclosure.

Referring to FIG. 9, the processor 110 may solve the N-queen problem by using a circuit 910 for initialization, a circuit 920 for the Oracle, and a circuit 930 for the amplification. The circuit 930 for the amplification may use two A_{N} gates, one C^{N}^{²}⁻¹−NOT gate, 2N² X gates, and two H gates.

According to some exemplary embodiments of the present disclosure, the total number of qubits required in the entire circuit diagram for solving the N-queen problem may be N²+4N-5. The time complexities for the circuit 920 for the Oracle and the circuit 930 for the amplification may be O(N³) as described above. The processor 110 may repeat the circuit 920 for the Oracle and the circuit 930 for the amplification at O(\sqrt{N!/L}) times. Therefore, the time complexities of the circuit 910 for the initialization, the circuit 920 for the Oracle, and the circuit 930 for the amplification performed by the processor 110 may be O(N³\sqrt{N!/}). A time complexity of an N-queen problem solving algorithm using the W state in the related art is O(N²\sqrt{N^{N}/L}). Therefore, it can be seen that the time complexity of the N-queen problem solving method performed by the computing apparatus 100 according to some exemplary embodiments of the present disclosure is reduced as compared with the time complexity according to the method in the related art.

The computing apparatus 100 according to some an exemplary embodiment of the present disclosure described above through FIGS. 1 to 9 can efficiently solve an N-queen problem by using a quantum substitution matrix state which is a superposition of qubits that satisfy a row condition and a column condition of the N-queen problem. Specifically, the computing apparatus 100 according to some an exemplary embodiment of the present disclosure may reduce a size of a data space in the related art and reduce a time required for solving the N-queen problem.

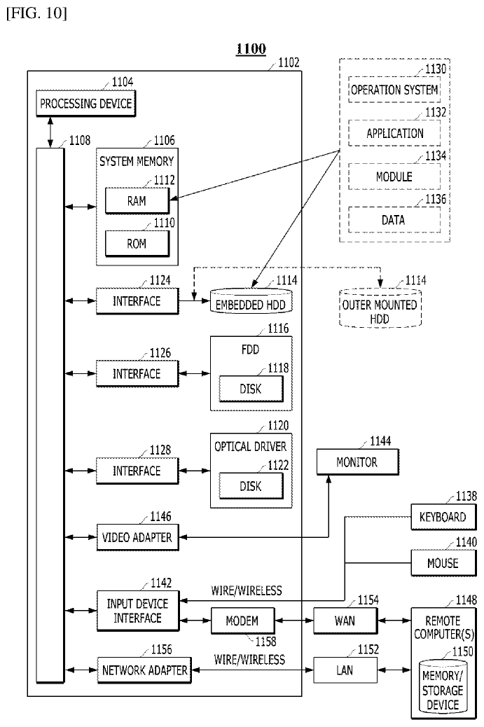

FIG. 10 is a simple and general schematic diagram illustrating an example of a computing environment in which exemplary embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an exterior mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means of setting a communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means of setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least three devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

What is claimed is:

1. A method for solving an N-queen problem performed by a computing apparatus, the method comprising:
an initialization step of generating a quantum substitution matrix state which is a superposition of qubit states satisfying a row condition and a column condition of the N-queen problem;
an Oracle step of performing an operation of inverting a phase of at least one entire correct answer state that satisfies a diagonal condition of the N-queen problem in the quantum substitution matrix state;
an amplification step of amplifying an amplitude of at least one entire correct answer state of which the phase is inverted;
amplifying the amplitude of at least one entire correct answer state to correspond to a predetermined value by performing the Oracle step and the amplification step repeatedly at a predetermined number of times; and
acquiring one first correct answer state among at least one entire correct answer state based on observation of a qubit state.

2. The method of claim 1, wherein the N-queen problem is a problem in which N queens are arranged not to attack each other in a chess plate with N horizontal and vertical cells, wherein the N is a natural number.

3. The method of claim 1, wherein the row condition is a condition that satisfies xᵢ₁+xᵢ₂+ . . . +x_{iN}=1 which is a first equation for all i when respective cells (i,j) in a chess plate with N horizontal and vertical cells are xᵢⱼ, an empty cell is 0, and a cell with the queen is 1, wherein the N, the i, and the j are the natural number.

4. The method of claim 1, wherein the column condition is a condition that satisfies x₁ⱼ+x₂ⱼ+ . . . +x_{Nj}=1 which is a second equation for all j when respective cells (i,j) in the chess plate with N horizontal and vertical cells are xᵢⱼ, the empty cell is 0, and the cell with the queen is 1, wherein the N, the i, and the j are the natural number.

5. The method of claim 1, wherein the diagonal condition is a condition that satisfies a third equation when respective cells (i,j) in the chess plate with N horizontal and vertical cells are xᵢⱼ, the empty cell is 0, and the cell with the queen is 1, wherein the N, the i, and the j are the natural number, and
the third equation is
$$\begin{matrix}{\sum }_{i = 1}^{n - 1} {x}_{i , n - i} \leq 1 for all n ∈ \{ 3 , 4 , … , N + 1 \} \\ {\sum }_{i = 1}^{n - 1} {x}_{i , N + n - i} \leq 1 for all n ∈ \{ 2 , 3 , … , N - 1 \} \\ {\sum }_{i = 1}^{n - 1} {x}_{i , i + n} \leq 1 for all n ∈ \{ 0 , 1 , … , N - 2 \} \\ {\sum }_{i = 1}^{n - 1} {x}_{+ ni , i} \leq 1 for all n ∈ \{ 1 , 2 , … , N - 2 \}\end{matrix} .$$

6. The method of claim 1, wherein the quantum substitution matrix state is
$$\frac{1}{\sqrt{N !}} \{ \vert \begin{matrix}1 & 0 & ⋯ & 0 \\ 0 & 1 & ⋯ & 0 \\ ⋮ & ⋮ & ⋱ & 0 \\ 0 & 0 & 0 & 1\end{matrix} 〉 + \vert \begin{matrix}0 & 1 & ⋯ & 0 \\ 1 & 0 & ⋯ & 0 \\ ⋮ & ⋮ & ⋱ & 0 \\ 0 & 0 & 0 & 1\end{matrix} 〉 + … + \vert \begin{matrix}0 & 0 & ⋯ & 1 \\ 0 & 0 & ⋯ & 0 \\ ⋮ & ⋮ & ⋱ & 0 \\ 1 & 0 & 0 & 0\end{matrix} 〉 \} ,$$
wherein the N is the natural number.

7. The method of claim 1, wherein the quantum substitution matrix state is formed based on a quantum operation.

8. The method of claim 7, wherein the quantum operation includes,
when respective cells (i,j) in the chess plate with N horizontal and vertical cells are xᵢⱼ, the empty cell is 0, the cell with the queen is 1, and the quantum operation is A_{N},
forming a state |W_{N} [symbol] by performing an operation W_{N} in qubits x₁₁, x₁₂, . . . , x_{1N},
performing an operation A_{N-1} in qubits xᵢⱼ(i, j=2, 3, . . . , N), and
performing an operation C-SWAP (x₁ᵢ, xⱼ₁, xᵢⱼ).

9. The method of claim 8, wherein the operation W_{N} is an operation of converting a state |0 [symbol] of N-qubits to the state |W_{N} [symbol] .

10. The method of claim 8, wherein the state |W_{N} [symbol] is
$$\frac{1}{\sqrt{N}} ( \vert {N}_{1} 〉 + \vert {N}_{2} 〉 + … + \vert {N}_{N} 〉 ) ,$$
wherein the N is the natural number.

11. The method of claim 8, wherein the operation C-SWAP (x₁ᵢ, xⱼ₁, xⱼᵢ) is an operation of exchanging two (xⱼ₁, xⱼᵢ) target qubits when a control qubit (x₁ᵢ) is 1 in three qubits.

12. A non-transitory computer readable medium storing a computer program, wherein the computer program comprises instructions for causing a processor of a computing apparatus for solving an N-queen problem to perform the following steps, the steps comprising:
an initialization step of generating a quantum substitution matrix state which is a superposition of qubit states satisfying a row condition and a column condition of the N-queen problem;
an Oracle step of performing an operation of inverting a phase of at least one entire correct answer state that satisfies a diagonal condition of the N-queen problem in the quantum substitution matrix state;
an amplification step of amplifying an amplitude of at least one entire correct answer state of which the phase is inverted;
amplifying the amplitude of at least one entire correct answer state to correspond to a predetermined value by performing the Oracle step and the amplification step repeatedly at a predetermined number of times; and
acquiring one first correct answer state among at least one entire correct answer state based on observation of a qubit state.

13. A computing apparatus for solving an n-queen problem, the apparatus comprising:
a processor including at least one core; and
a memory for storing computer programs executable by the processor,
wherein the processor is configured to:
perform initialization of generating a quantum substitution matrix state which is a superposition of qubit states satisfying a row condition and a column condition of the N-queen problem,
perform an Oracle of performing an operation of inverting a phase of at least one entire correct answer state that satisfies a diagonal condition of the N-queen problem in the quantum substitution matrix state,
perform an amplification of amplifying an amplitude of at least one entire correct answer state of which the phase is inverted,
amplify the amplitude of at least one entire correct answer state to correspond to a predetermined value by performing the Oracle and the amplification repeatedly at a predetermined number of times, and
acquire one first correct answer state among at least one entire correct answer state based on observation of a qubit state.
